(19) United States
(12) Patent Application Publication
(10) Pub. No.: US 2010/0088905 A1
(43) Pub. Date: Apr. 15, 2010

(54) CHAIN SAW EQUIPPED WITH A DEVICE FOR ADJUSTING THE TIGHTNESS OF THE CUTTING CHAIN

(75) Inventor: Roger Pellenc, Pertuis (FR)

Correspondence Address: EGBERT LAW OFFICES, 412 MAIN STREET, 7TH FLOOR, HOUSTON, TX, 77002, US

(73) Assignee: PELLENC (Societe Anonyme), Pertuis (FR)

(21) Appl. No.: 12/527,664

(22) PCT Filed: Feb. 25, 2008
(86) PCT No.: PCT/FR2008/000243

§ 371 Date: Dec. 7, 2009

(30) Foreign Application Priority Data
Feb. 26, 2007 (FR) 07/01355

(51) Int. Cl. B27B 17/02; B27B 17/14

(52) U.S. Cl. 30/386

(57) ABSTRACT

The chain saw of the present invention includes a cutting device having a cutting chain mounted to turn around a drive sprocket and a guide bar which can be immobilized on a body by a jamming device and moved in two directions tending to move it closer to or further away from the drive sprocket relaxing the tension of the chain or ensuring its tension, respectively. The chain saw features a pushing device tending to automatically move the guide bar away from the drive sprocket, when the jamming device is loosened. The pushing device is formed by a slide against the rear end of which rests the rear end of the guide bar and an elastic component, preferably constituted by a helical spring resting, through the intermediary of its opposite ends against a fixed element of the body and against a surface of the front end of the slide.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention concerns a chain saw equipped with a device for adjusting the tightness of the cutting chain.

2. Description of Related Art Including Information Disclosed Under 37 CFR 1.97 and 37 CFR 1.98.

Such chain cutting tools are usually called chain saws and are commonly used to cut various materials (wood, concrete, bricks, tiles, etc.). They include a cutting device constituted by an endless cutting chain turning around a drive sprocket and a chain guide generally of an oblong shape and equipped with a peripheral guide bar and a power source for the drive of this chain by means of said sprocket. To perform a satisfactory and safe job, it is indispensable for the chain to be perfectly tensioned. As a matter of fact, when this chain is loose, it represents a major risk of jumping off the sprocket and breaking, thereby putting the operator at risk of injury. On the other hand, when the chain is too tight, this results in faster wear of the chain and the guide bar, abnormal overheating of both the chain and the guide bar, higher energy consumption and loss of efficiency of the cutting device that could lead to its seizing up.

On account of the fact that the chain slackens by itself due to the wear of the chain pins while the chain is in use, adjustment of its tension cannot be made once and for all but must instead be repeated regularly, whenever said chain becomes loose. This is a delicate and complicated operation because it is difficult for the operator to determine and to obtain the tension that is just right.

Numerous devices have been offered to date for adjusting the tension of the cutting chain, which requires removal of the guide bar which tends to move further away from the drive sprocket. However, none of these devices permits a satisfactory automatic adjustment of this tension. In general the adjustment principle for the tension means actuating a tensioning device parallel to the guide bar.

These known devices require much experience to obtain an adjustment to the proper tension, and, in spite of such experience, a good adjustment is not always assured.

### BRIEF SUMMARY OF THE INVENTION

It is the particular aim of the invention to allow automatic adjustment of the tension of the cutting chain of chain saws and also to facilitate obtaining this automatic adjustment. The invention also aims at making the operation of chain replacement easier whenever this turns out to be desirable.

The invention refers to a chain saw which includes a cutting device constituted by a cutting chain mounted so that it turns around a drive sprocket and a guide bar that can be immobilized on a body by means of a jamming device and which can be moved in two directions to either bring it closer to or further away from the drive sprocket in order to loosen the tension of the chain or to ensure its tension respectively. This chain saw is remarkable in that it comprises a pushing device which tends to automatically move the guide bar away from the drive sprocket when the jamming device is loosened. The pushing device is constituted, on the one hand, by a slide against the proximal end of which rests the proximal end of the guide bar, and on the other hand, by an elastic component, preferably consisting of a helical spring resting, with its opposed ends, against a fixed element of the body, and against a surface of the distal end of said slide.

In case of a relaxation of the tension of the chain previously mounted on the guide bar of the saw, it is clear that all one has to do is loosen and then re-tighten the jamming device in order to obtain a proper re-tensioning of the chain.

The particular advantages of the invention are:
obtaining an automatic adjustment of the proper chain tension due to the pre-dimensioned and preset pushing device;
simplicity of activation and rapidity of adjustment;
no need for a specific tool;
easily doable with no experience needed; and
safety, no risk of injury, the hands do not touch the chain.

According to another characteristic arrangement, the chain saw comprises a retractable retaining device, which automatically immobilizes the guide bar, in opposition to the counteraction of the elastic component of the pushing device, in a position where it finds itself closer to the drive sprocket. The release of this retaining device results automatically in the distancing of said guide bar in relation to said drive sprocket and the tensioning of the chain, under the action of the pushing device.

Because of this arrangement, removal of the worn chain and its replacement by a new chain can be performed easily, quickly and safely, with no risk of injury. The same goes for replacement of the guide bar or its reversal.

According to another characteristic arrangement, the pushing device and the retaining device of the guide bar form a functional assembly including a slide positioned below the proximal end of the guide bar, the proximal end of this slide being equipped with at least one, and preferably two stop and catch hooks against which rests the proximal end of the guide bar. The elastic component is jammed, at its distal end, against a surface of the distal end of the slide, with a retractable retainer mounted directly below said slide ensuring automatically the immobilization of the latter when it reaches the end of its backward motion.

According to an advantageous method of manufacture, the retractable retainer is integral with an operating pin for pushing said retainer in and releasing the retainer device.

According to a method of manufacture, the operating pin of the retractable retainer is oriented in the direction of a cover fastened on the body of the apparatus and the length of the operating pin is such that the pin is automatically pushed in when said cover is put in place on the body, thus suppressing and effacing said retractable retainer and allowing the motion of the slide towards the front of the apparatus, under the action of the pusher.

According to another preferred setup the retractable retainer is subjected to the action of a pressure device advantageously formed by a helical spring intended to push it back into the slide blocking position.

According to another advantageous arrangement, the slide is maintained on the body of the saw by means of a guide shoe mounted at the end of a fastening rod attached to the body and crossing a longitudinal slot made in said slide. This guide shoe sits astride the edges of said slot, being so shaped as to ensure guidance without any noticeable play of the guide bar, during the longitudinal movements of the latter. More precisely, the part of the slot of the guide bar that is meant to slide on the shoe is of a width, which allows the sliding of said guide bar without any noticeable play on the parallel sides of said shoe.

According to another characteristic arrangement, the body has a contact face against which the guide bar is pressed, and this contact face has a recess into which the slide can move by means of one of its plane surfaces, and the opposite surface of said slide is immersed in relation to said contact and jamming face.

### BRIEF DESCRIPTION OF THE SEVERAL VIEWS OF THE DRAWINGS

The invention will be better understood when reading the description below, given solely as an example and made with reference to the attached drawings.

FIG. 1 is a perspective view, with pull-off, of a chain saw in conformance with the invention.

FIG. 2 is an exploded view, in perspective, of the chain saw shown in FIG. 1.

FIG. 3 is a sectional view along plane III of FIG. 1.

FIG. 4 is a sectional view along plane IV of FIG. 1.

FIG. 5 is a sectional view analogous to FIG. 4, showing the automatic adjustment of the tension of the chain saw of FIGS. 1 and 2.

FIG. 6 is a side elevational view with pull-off, which shows a stage of disassembly of the chain saw of FIGS. 1 and 2.

FIG. 7 is a sectional view analogous to FIG. 4, showing another stage of disassembly of the chain of the chain saw of FIGS. 1 and 2.

FIG. 8 is a top plan view of the body of the chain saw on which the slide and the retainer catch are shown in a position corresponding to the far position of the guide bar (shown in thin lines) in relation to the drive sprocket.

FIG. 9 is a top plan view analogous to FIG. 8, showing said slides and retainer latches in a position corresponding to a near position of the guide bar in relation to the drive sprocket.

FIG. 10 is a detailed top plan view illustrating more specifically the guidance of the guide bar on the guidance and slide holding shoe.

FIG. 11 is a top plan view of a guide bar equipped of a slot so shaped that it can slide without any noticeable play on two opposing sides of said shoe, being this guided by the latter.

### DETAILED DESCRIPTION OF THE INVENTION

Reference to said drawings is made to describe an advantageous example of execution, although by no means limiting, of the chain saw in accordance with the invention.

This invention applies to any type of chain saw (hand-held chain saw, telescopic pole chain saw, etc.).

In the following and in the attached claims, the terms “before”, “after”, as well as similar terms refer to the position of the guide 4 and of the chain 2 in relation to the rest of the chain saw 1, considering that the guide 4 and the chain 2 project from the front of said chain saw 1.

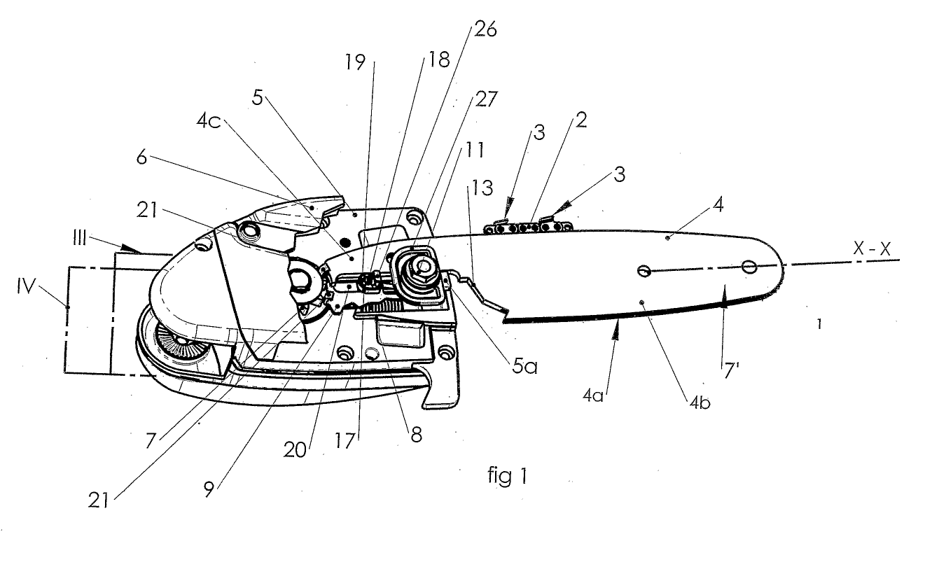

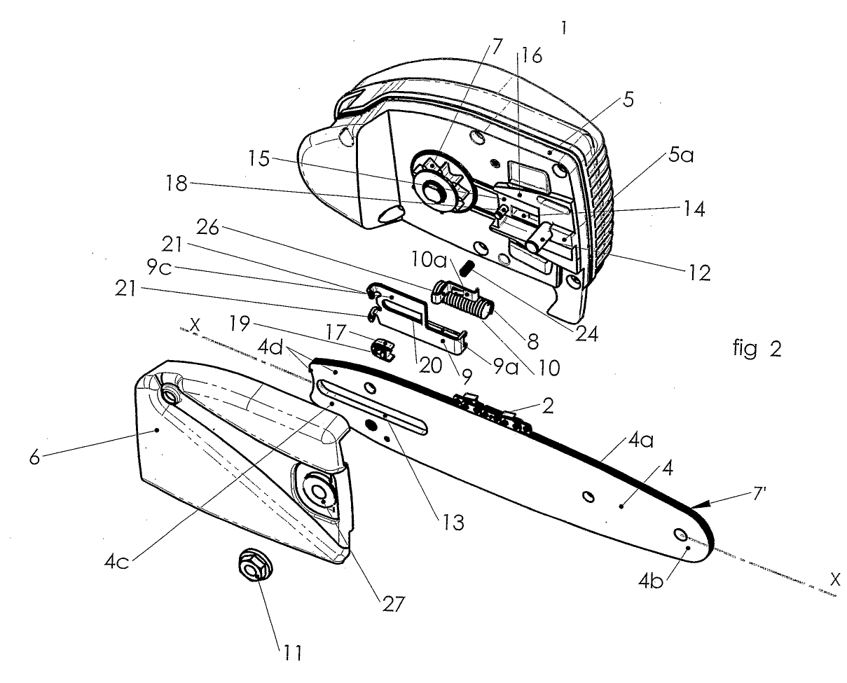

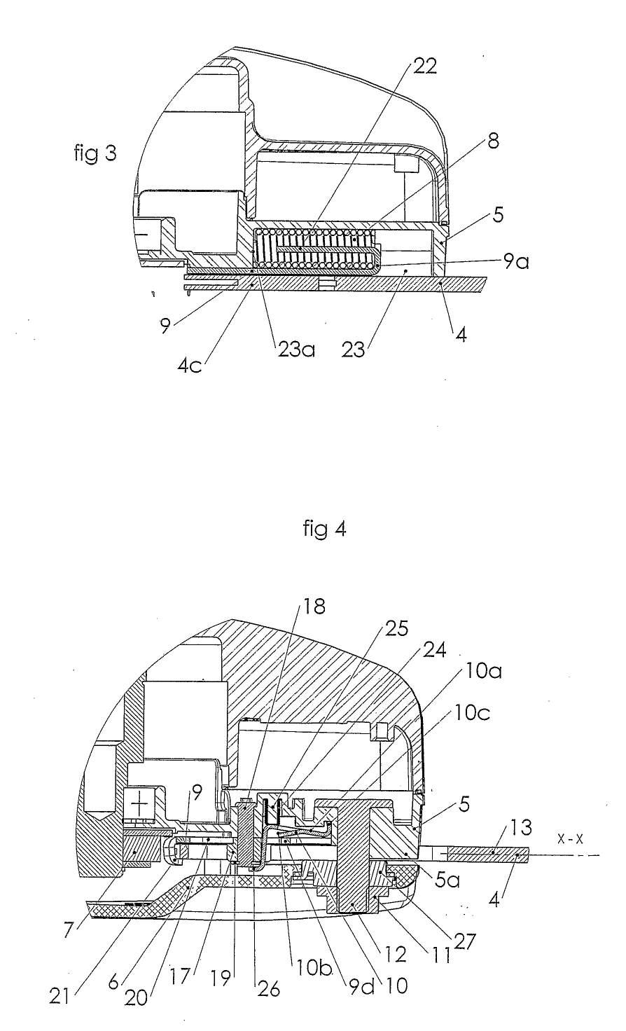

On FIGS. 1 and 2, a chain saw is shown which includes, in the classic manner, a cutting device comprising an endless cutting chain 2, turning around a drive sprocket 7 and a guide bar 4 generally of an oblong shape and equipped with a peripheral guide rail 4a of said chain and a return sprocket 7′ positioned at the distal end or the front end 4b of this guide bar. A power source (not shown) coupled to the drive sprocket 7, for instance consisting of an electric motor or a thermal engine, ensures the drive of the cutting chain 2 by means of said drive sprocket 7. The articulated cutting chain is constituted in the known manner of drive links, cutter links 3 (or cutting teeth) and of side links interconnected by link pins and rivets.

In its proximal part or rear part 4c, the guide bar 4 is equipped with a longitudinal slot 13 allowing its guidance in translational motion during its movements in relation to the body 5 which features at its forward end, a guidance element consisting of a projection 5a which has two parallel sides against which the edges of said slot 13 can glide.

The guide bar 4 is mounted, through the intermediary of its proximal part 4c, between two elements 5 and 6 one of which may be constituted by a cover 6 fixed on the other which is called “body” 5 in the continuation of this statement, through the intermediary of a jamming device allowing: either to immobilize the guide bar 4 on the body 5, or to permit the movements of said guide bar 4 towards the rear or forward, that is to say in two directions to bring it closer or to distance it further from the drive sprocket 7, so as to relax the tension of the chain 2-3 or to ensure its tension, respectively.

The jamming device allows to perform, at the same time, jamming and blocking the guide bar 4 on the body 5 and the fastening of the cover 6 on said body. It consists for example of a threaded rod 12 made integral with the body 5 and a nut 11 which is screwed on the threaded end portion of said threaded rod. Advantageously, especially when the cover 6 is made of rigid plastic material, the latter may be equipped with a metallic grip housed with an aptitude for axial movement and retained in an opening made in a recess provided in said cover 6 so that it finds itself crossed by the threaded rod 12 of the jamming device during the installation of the cover 6 on the body 5. This grip 27 resting on a surface of the distal part 4c of the guide bar 4 allows a sturdy jamming of the latter against the body 5 by screwing the nut 11 onto the rod 12 while participating in the fastening of the cover 6 on said body.

According to an important characteristic arrangement of the invention, a pushing device tends to automatically push the guide bar forward, that is to say into a position moving it away from the drive sprocket 7 when the jamming device is loosened, so as to perform an automatic tensioning or re-tensioning of the chain 2.

Advantageously this pushing device includes a slide 9, the proximal end of which is equipped with a stop against which rests the proximal end 4d of the guide bar 4 and an elastic component, preferably constituted by a helical spring 8 resting through the intermediary of its opposing ends on the one hand against a fixed component of the body 5, and on the other hand against a surface 9a of the distal end of the slide 9.

This helical spring 8 which has a length and stiffness or return force that were selected in order to obtain good tension of the chain 2, is jammed, through the intermediary of its opposite ends, on the one hand, against the proximal end or rear end 23a of a groove 23 made in the body 5 and in which is placed said spring, and, on the other hand, against a distal surface 9a of the slide 9 resting, through the intermediary of its proximal part 21, against the distal end 4d of the guide bar 4. The groove 23 is made in the body 5, below the location where the slide 9 is mounted and parallel to the axis of movement of the latter.

The spring 8 can be slipped, by its distal part, over a rod 22 which is integral with the distal end 9a of the slide 9 and which may be formed of a single piece with the latter, this rod extending towards the rear.

According to another characteristic arrangement of the invention, the chain saw features a retaining device which is advantageously constituted by a retractable or effaceable retainer 10 which allows to automatically immobilize the guide bar 4, in opposition to the counteraction of the elastic pusher 8, in a position where it finds itself closer to the drive sprocket 7. The saw is also laid out so that the release of this retainer automatically leads to the forward movement of the guide bar 4 and the tensioning of the chain, under the action of the pusher.

The retractable or effaceable retainer 10 forms, in its active blocking position, an obstacle, which a front edge 9d of the slide 9 hits against.

Preferably the pusher 8 and the retaining device 10 of the guide bar form a functional assembly including the slide 9 arranged below the proximal part 4c of the guide bar 4, the proximal end or the rear end of this slide being equipped with at least one, preferably two stop and catch hooks 21 which the proximal end or the rear end 4d of the guide bar 4 rests against. The elastic pusher component 8 is jammed, by its distal end, against a surface 9a of the distal end or front end of the slide 9, ensuring automatically the immobilization of the latter when it reaches the end of its backward movement.

The hook 21 or each hook 21 is constituted by a forward-bent grip to facilitate the assembly and disassembly operations of the guide bar 4. As a matter of fact, due to this configuration, the hooks 21 allow the guide bar 4 to be lifted and tilted around a supporting point constituted by the bottom of said hooks, at an angle in the order of 45° from the mounting position of said guide bar, thus facilitating the replacement operations of the chain and/or the guide bar.

The retractable retainer 10 is integral with an operating pin 26, which permits the depression of said retainer and the release of the retaining device. Preferably, the operating pin 26 is made of a single piece together with the retractable retainer 10.

The operating pin 26 of the retractable retainer 10 is oriented in the direction of the cover 6 attached on the body 5 of the apparatus, and this operating pin 26 is of such a length that it is automatically depressed when the cover is placed on the body, so as to retract said retainer and to allow the movement of the slide 9 towards the front of the apparatus, under the action of the spring 8.

The retractable retainer is subject to the action of a pressure device advantageously consisting of a helical spring 24 that tends to push it back into the blocking position of slide 9. This return spring 24 is, for example, slipped over a rod 25 that is integral with the body 5 and it is jammed, by the intermediary of its opposite ends, on the one hand against a fixed surface of said body, and, on the other hand, against the rear surface of the mounting device 10a of said retractable retainer 10.

The retractable retainer 10 has an inclined position rising towards the rear in relation to the central plane face 9b of the slide 9 and it is depressed into its recess 14 in opposition to the counteraction of the spring 24 when the slide 9 recedes. When the front edge 9c of the slide 9 passes the nose 10b of the retainer 10, the retainer is pushed back by said spring 24 and places itself in front of said front edge, thus prohibiting any movement tending to move the slide 9 and the guide bar 4 away from the drive sprocket 7.

According to the mode of execution shown, when the slide 9 is moved away from the sprocket 7, the retainer 10 is lodged in a slot 20 of said slide. When the slide recedes, the retainer is suppressed in its recess 14 by the force exerted by the small cross bar 9d located at the front end of said slot 13. When the small cross bar 9d passes the nose 10b of the retainer 10, the retainer is pushed back by the spring 24 and places itself in front of said cross bar 9d, thus forming a stop, prohibiting any movement tending to move the slide 9 and the guide bar 4 away from the drive sprocket 7, for instance, when changing the chain or the guide bar.

The body 5 features a contact face 16 against which the guide bar is jammed, and this contact face is provided with a recess 15 into which the slide 9 can move through the intermediary of one of its plane faces. The opposite surface 9e of said slide is in retraction in relation to said contact and jamming face 16. The slide 9 is guided, during its movements, by the longitudinal parallel edges of the recess or seat 15.

The slide 9 is maintained under the body 5 in its recess 15 by means of a shoe 17 mounted at the end of a rod 18, for instance by means of an elastic retaining snap ring, said rod crossing the longitudinal slot 20 made in the slide 9 and being fastened on the body 5.

The holding shoe 17 straddles the edges of the slot 20 and is shaped and sized so as to ensure guidance without any noticeable play of the guide bar 4 during longitudinal movements of the latter. It has for example a square shape so as to offer two parallel sides against which the opposite parallel sides of the slot 13 of the guide bar can slide. The portion 13a of the slot 13 of the guide bar 4 meant to slide on the holding and guiding shoe 17 is of a width L, allowing a sliding movement of said guide bar, without any noticeable play, on the parallel sides of said shoe. According to a characteristic arrangement, this width L is 9 mm or above.

The holding portion 17 serves also as a guiding element for the slide 9.

The functioning of the chain saw adjusting device according to the invention is described below.

Ready for use, the chain saw 1 is as shown in FIG. 4, on which the guide bar 4 is blocked by jamming between the body 5 and the jaw 27 slipped over the rod 18 and tightened by the nut 11. The jaw 27 also immobilizes the cover 6 by pressing it against the guide bar 4 and the body 5.

In this position, the effaceable retainer 10 has receded in its recess 14 by the front edge or small bar 9d of the slide 9 resting against said retainer.

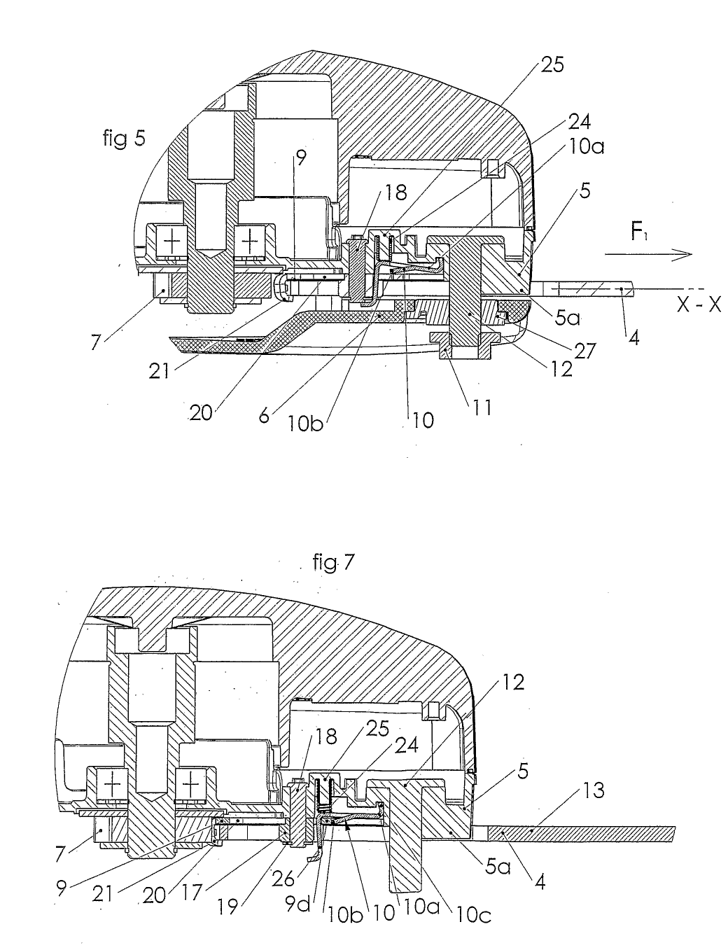

When the chain 2 is relaxed, its tension is newly adjusted simply by loosening and then re-tightening the nut 11, which has the advantage of being extremely simple, fast and safe to do. When the nut 11 is loosened, the spring 8 automatically returns the slide 9 to the front, as illustrated by the arrow F1 in FIG. 5. Thereby this spring 8 re-tensions the chain 2 by stressing the guide bar 4, through the intermediary of the slide 9, in the opposite direction from the drive sprocket 7. The tightness or return force of the spring 8 is selected so that this spring 8 tensions the chains 2 in an essentially optimal manner for the type of work for which the chain saw is intended. In other words, the spring 8 performs automatically an efficient and precise adjustment of the tension of the chain, when the nut 11 is loosened. The subsequent tightening of the screw 11 sets this adjustment by immobilizing the guide 4 again in relation to the sprocket 7.

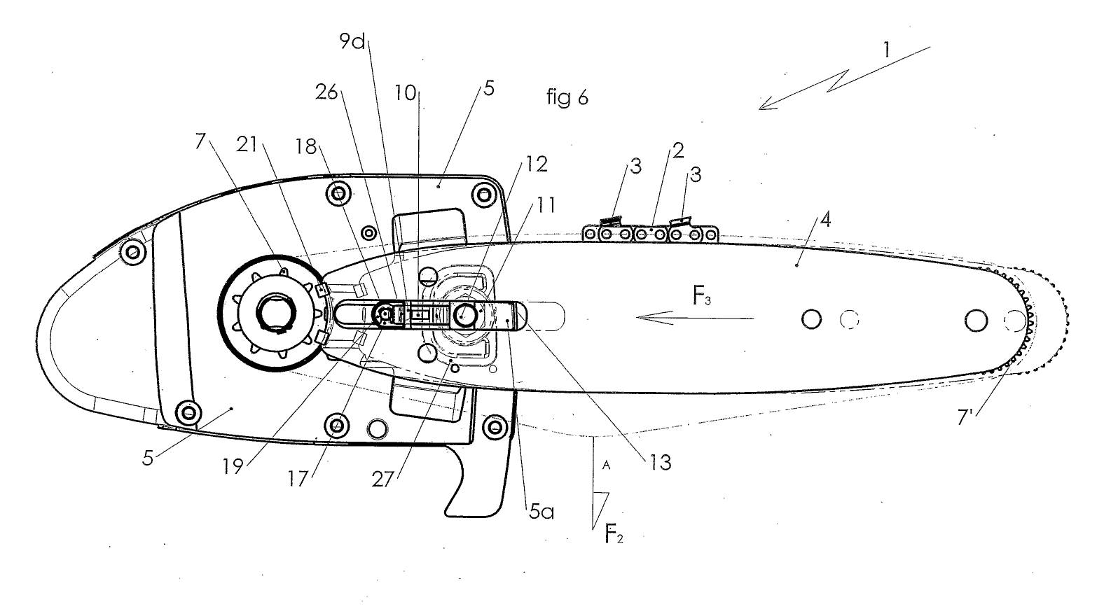

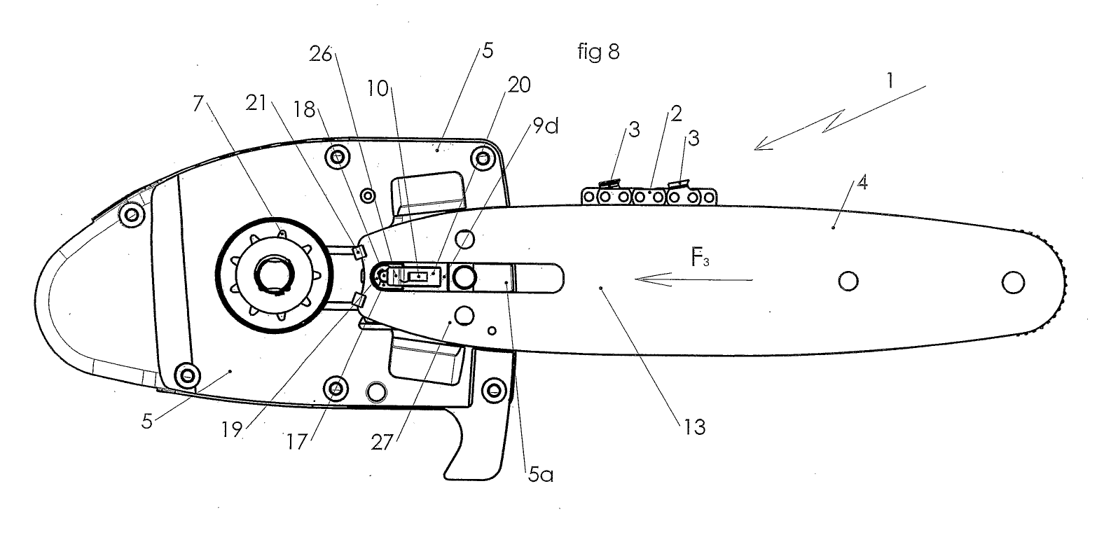

To remove the chain 2, the nut 11 must first be loosened. Then the guide bar 4 is pushed backwards, i.e., towards the drive sprocket 7, in opposition to the counteraction of the spring 8, until the front edge 9d of the slide 9 has passed the nose 10b of the pivoting retainer 10. To do this, one can simply pull sideways on the chain 2, as shown by the arrow F2 in FIG. 6, where the initial position of the guide bar 4 and of the slide 9 is shown in chain-dotted lines. The tension F2 applied to the chain 2 moves the guide bar 4 backwards, as shown by the arrow F3 on the same FIG. 6, without requiring a significant or dangerous effort. When the front edge 9d of the slide 9 passes the nose 10b of the pivoting retainer 10, the spring 24 pivots said retainer into the blocking position shown in FIG. 7, on which said retainer 10 retains the slide 9 by its nose or front edge 10b, in opposition to the action of the spring 8, by preventing any forward movement of said slide.

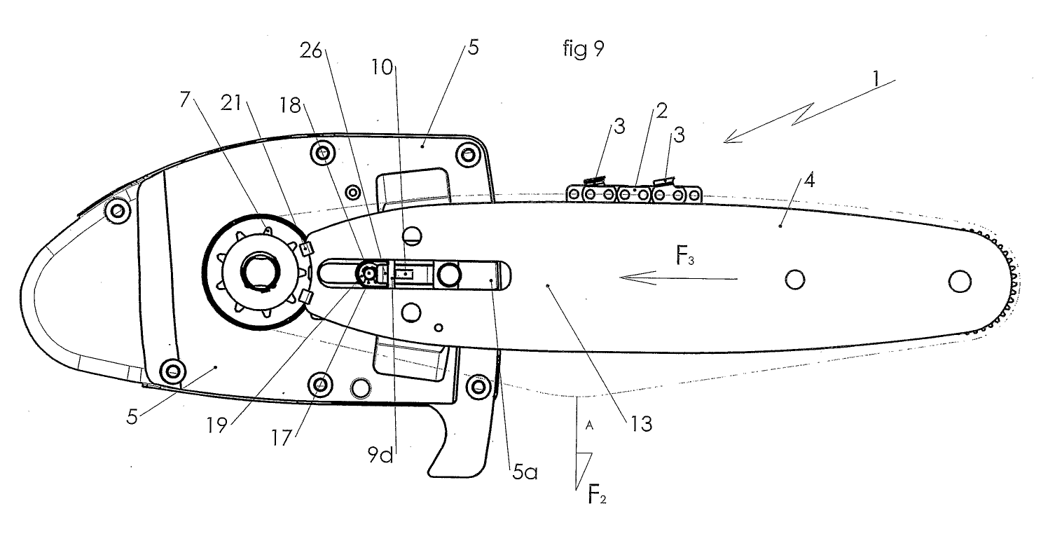

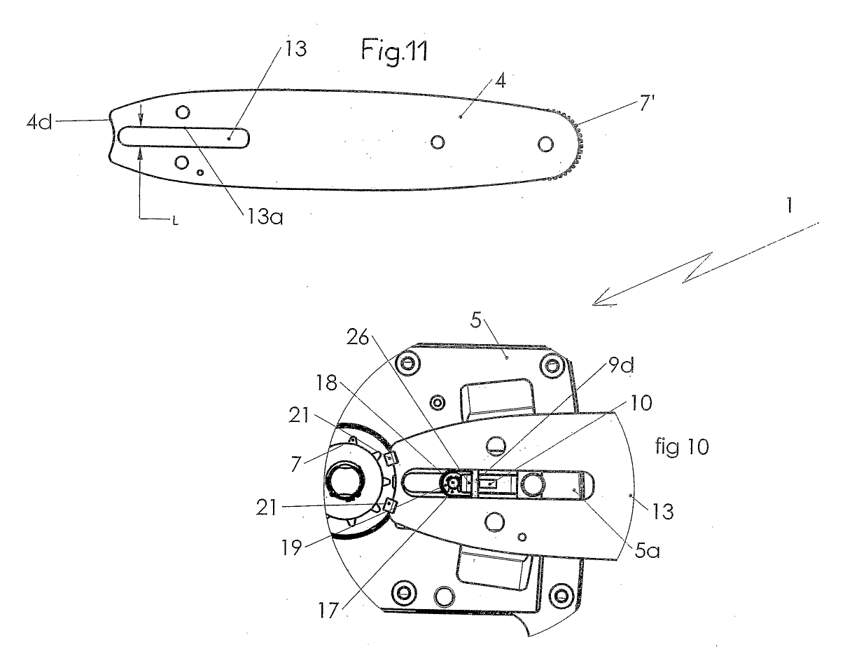

In this position illustrated in FIGS. 6, 7, 9, and 10, the guide bar 4 has moved backwards, i.e., it is placed in a proximal position closer to the drive sprocket 7, so that the chain 2 is loose and can be removed, for instance to be replaced, after removal of the cover 6. Removal of this chain 2 is then easy and safe, to the extent that the return action of the spring 8 has been canceled out by the retainer 10.

When the chain 2 has been removed, it is possible, if necessary, to easily withdraw the guide bar 4 which the retainer 10 and the slide 9 are still isolating from the return action of the spring 8. This guide bar 4 or any other replacement guide bar 4 can then easily be re-installed, while the retainer 10 still maintains the slide 9 in the backward position.

The removal or installation of the guide bar are facilitated by the provision of the hooks 21 which are wide open towards the front and which are to be found at the distal end of the slide, as previously indicated.

While the slide 9 is still being retained in its backward position, a new chain 2 can easily be installed over the drive sprocket 7 and the guide bar 4. Once this has been done, the cover 6, the jaw 27 and the nut 11 are replaced in position. While this nut 11 is fastened, the cover 6 is pushed towards the body 5 and, through the intermediary of the operating pin 26, pushes the retainer 10 towards its withdrawal position as per FIG. 4, in opposition to the action of the spring 24. The retraction of the retainer 10 releases the slide 9, which is then again pushed forward by the spring 8 and which in turn pulls the guide bar 4 to a tensioning position of the chain 2. After the action of the spring 8 has thus automatically performed the tensioning of the chain 2, the continuation of tightening of the nut 11 leads to the jamming of the jaw 27 on the guide bar 4 which is thus securely immobilized between said jaw 27 and the body 5 of the apparatus, the cutting chain being in its properly tensioned position. The chain saw is again ready for use.

1. Chain saw comprising:
a cutting device being comprised of a cutting chain turning around a drive sprocket and a guide bar, the device being immobilized on a body by a jamming device being moveable in two directions tending to move closer to or further away from the drive sprocket relaxing tension of the chain or ensuring the tension, respectively; and
a pushing device automatically moving the guide bar away from the drive sprocket, when the jamming device is loosened, said pushing device being comprised of a slide having a rear end resting against a rear end of the guide bar and, an elastic component, being comprised of a helical spring resting through an intermediary of opposing ends thereof against a fixed element of the body and against a surface of the front end of the slide.

2. Chain saw as per claim 1, further comprising:
a retractable retainer automatically immobilizing the guide, in opposition to counteraction of the elastic element of the pushing device, in a position closer to the drive sprocket.

3. Chain saw as per claim 2, wherein said retractable retainer is comprised of, in an active blocking position, an obstacle against which abuts a front end of the slide.

4. Chain saw as per claim 2, wherein the retractable retainer automatically leads to the guide bar moving further away from the drive sprocket and tensioning of the cutting chain under action of the pushing device when the retractable retainer is released.

5. Chain saw according to claim 2, wherein the pushing device and the retaining device of the guide bar form a functional assembly, comprising a slide located below a rear part of the guide bar, a rear end of said slide being equipped with at least one stop and catch hooks against which rests a rear end of the guide bar, the pushing element being pressed, through an intermediary of a front end, against a surface of a front end of the slide, with a retractable retainer, and mounted below said slide automatically ensuring immobilization when reaching an end of receding movement.

6. Chain saw according to claim 5, wherein the retractable retainer is integral with an opening pin, suppressing the retainer and and releasing the retaining device, resulting automatically in the guide bar being moved further away from the drive sprocket, tensioning of the chain under the action of the pushing device.

7. Chain saw as per claim 6, wherein said operating pin is oriented in a direction of a cover being fastened on the body and has a length automatically suppressed when said cover is put in place on the body, the retainer being pushed back and retracted, moving the slide and the distancing of the guide bar from the drive sprocket under action of the pushing device.

8. Chain saw according to claim 5, wherein the retractable retainer is subjected to action of a means of pressure pushing the retractable retainer back into a slice blocking position.

9. Chain saw according to claim 8, wherein the means of pressure is comprised of a helical spring installed in a recess made in the body below the slide.

10. Chain saw as per claim 8, wherein the means of pressure is arranged around a guide rod integral with the body.

11. Chain saw according to claim 1, wherein the slide is maintained on the body by a guide shoe being mounted at an end of a fastening rod attached on the body and crossing a longitudinal slot made in said slide, said guide shoe straddling edges of said slot and being shaped so as to ensure guidance without any noticeable play of the guide bar during movements of the guide shoe.

12. Chain saw according to claim 11, wherein the guide bar is equipped, in on a rear part thereof, with a longitudinal slot, a portion of the slot of the guide bar sliding on the shoe having a width, a sliding motion being without noticeable play of said guide bar on parallel sides of the shoe.

13. Chain saw according to claim 12, wherein said portion of the slot has a width of 9 mm or more.

14. Chain saw according to claim 11, wherein the guide shoe further comprises a slide guidance element during movements.

15. Chain saw according to claim 1, wherein the body comprises a contact face against which is pressed the guide bar, said contact face being provided with a recess into which the slide moves through the intermediary of one of its plane surfaces, an opposite surface of said slide being retracted in relation to said contact and pressure face.

16. Chain saw according to claim 5, wherein the retractable retainer has an inclined position rising in a direction towards a back side, in relation to a central place face of the slide, the retractable retainer pushing into a recess thereof in opposition to counteraction of a spring when the slide recedes, and pushing back into the stop position when the front edge of said slide passes the blocking nose of said retainer.

17. Chain saw according to claim 5, wherein the stop and catch hook or each stop and catch hook is comprised of a forward-bent jaw.
